(19) United States
(12) Patent Application Publication
(10) Pub. No.: US 2025/0318037 A1
(43) Pub. Date: Oct. 9, 2025

(54) STATIC ELECTRICITY ELIMINATOR FOR CHARGED FLUIDS

(71) Applicant: PILLAR Corporation, Osaka (JP)

(72) Inventors: Atsushi Nakano, Osaka (JP); Katsuhiko Fukui, Osaka (JP); Hidetaka Shiozaki, Osaka (JP)

(21) Appl. No.: 19/089,785

(22) Filed: Mar. 25, 2025

(30) Foreign Application Priority Data
Apr. 9, 2024 (JP) 2024-062529

(51) Int. Cl. H05F 3/02

(52) U.S. Cl. CPC H05F 3/02

(57) ABSTRACT

A static electricity eliminator, which is a device for eliminating static electricity from a fluid inside a pipe, includes a static electricity eliminating rod, which is made of conductive resin, configured to prevent penetration of the fluid, grounded electrically, and placed inside a flow path in the pipe to intersect with a center portion of the flow path. The static electricity eliminating rod includes a hollow, which is positioned to intersect with the center portion of the flow path and piercing the static electricity eliminating rod in a direction parallel to the flow path.

### CROSS-REFERENCE TO RELATED APPLICATIONS

This application claims priority under 35 U.S.C. § 119 (b) to Japanese Application No. 2024-062529, filed Apr. 9, 2024, the disclosures of each of which are incorporated herein by reference.

### TECHNICAL FIELD

The invention relates to plumbing equipment, and in particular, technologies of eliminating static electricity from fluids inside pipes.

### BACKGROUND ART

A semiconductor process uses various chemical solutions or ultrapure water for applying resists to wafers, cleaning wafers, and the likes. Plumbing equipment for treating such fluids including tubes, pipe fittings, valves, pumps, and the likes is installed in a semiconductor manufacturing apparatus. The plumbing equipment is characterized by its fluid contact parts made of nonmetals such as resins due to the necessity of preventing fluids contaminated with metals from causing crystal defects in semiconductors and deterioration of their electric characteristics. The plumbing equipment is also characterized by relatively frequent maintenance such as cleaning due to the necessity of preventing, at its various positions, accumulation of particles causing inadequate processing of traces and accumulation of organic substances causing inadequate deposition. In view of these characteristics, the plumbing equipment of the semiconductor manufacturing apparatus requires ease of assembly and disassembly as well as high seal performance.

Since pipes have non-metallic fluid contact portions, flow electrification easily occurs in low-conductivity fluids such as organic solvent solutions and ultrapure water. Excessively charged fluids tend to induce damage of seals at valves or the likes due to dielectric breakdown, thereby causing possible leakage. When electric charges carried by charged fluids are accumulated on a wafer, they could destroy semiconductor elements. In addition, a spark discharge in a charged flammable organic solvent has a risk of resulting in a fire. For those reasons, the technologies disclosed in Patent Literatures 1 and 2 provide electric conductivity to a portion of the inner wall of a flow path by, for example, mixing carbon fibers into a gasket or seal member, and then, connects the portion to ground. The technologies disclosed in Patent Literatures 3 and 4 allow fluids to pass through a metallic mesh or filter.

### CITATION LIST

Patent Literature 1: JP H04-129993 U
Patent Literature 2: JP 2022-114505 A
Patent Literature 3: JP 2022-305095 A
Patent Literature 4: JP 2003-202098 A

### SUMMARY OF INVENTION

Like the technologies disclosed in Patent Literatures 1 and 2, technologies of providing an inner wall of a flow path with a highly conductive section connected to ground, which is hereinafter referred to as “static electricity eliminating section,” can eliminate static electricity from fluids passing near the inner wall of the flow path, but they cannot easily eliminate it from fluids passing through a portion of the flow path that includes the radial center thereof and its vicinity, which is hereinafter abbreviated as the “center portion.” This is because fluids capable of accumulating seriously many charges have very low conductivity, which is typically 10⁻⁸ S/m or less, and make it difficult to move electric charges from the center portion of the flow path to the inner wall thereof during passage of the fluids through the static electricity eliminating section. Neither a longer static electricity eliminating section that allows charges to move the center portion to the inner wall during the passage of the fluids, nor a system for applying electric or magnetic fields to the fluids within the static electricity eliminating section to cause charges to move the center portion to the inner wall, is a practical solution since it requires a larger or more complicated structure for eliminating static electricity.

Use of the mesh or filter disclosed in Patent Literature 3 or 4 is preferred only for the purpose of sufficiently eliminating static electricity from the fluids even within the center portion of the flow path. This is because the mesh and filter contact the fluids not only near the inner wall of the flow path but also within the center portion thereof. However, the mesh and filter, which are made of metal, have a high risk of polluting the fluids with metal when they are used in the semiconductor process. It is difficult to change the material of the mesh or filter from metal to conductive resin since the mesh and filter made of conductive resin, due to their shapes flat along the flow direction, have too high electric resistances to eliminate a sufficiently large number of charges. A thicker mesh or filter with a lower resistance can easily cause an excessive pressure loss of the fluids.

An object of the invention is to solve the above-mentioned problems, and in particular, to provide a technology of eliminating static electricity from the entirety of fluids within a pipe while keeping a low-pressure loss of the fluids.

A static electricity eliminator according to one aspect of the invention is a device for eliminating static electricity from a fluid inside a pipe. The eliminator includes a static electricity eliminating rod, which is made of conductive resin, configured to prevent penetration of the fluid, grounded electrically, and placed inside a flow path in the pipe to intersect with a center portion of the flow path. The rod includes a hollow positioned to intersect with the center portion of the flow path. The hollow pierces the rod in a direction parallel to the flow path.

When the pipe is a manifold, the above-described static electricity eliminator may further include a fixing portion, which is formed as a closure, i.e., a stopper that closes an unnecessary opening end of the manifold and that is also called as a plug or a cap. The fixing portion removably closes a branch pipe of the manifold. From the fixing portion, the static electricity eliminating rod may extend through the branch pipe of the manifold to the center portion of the flow path or farther. The rod may include a plurality of fins. Each fin extends from the inside of the branch pipe closed by the fixing portion to the center portion of the flow path or farther in a direction parallel to the flow path. In that case, the hollow is one or more slits defined by the fins.

The above-mentioned static electricity eliminator uses the static electricity eliminating rod to guide, into the hollow of the rod, fluids passing through the center portion of the flow path in the pipe. Accordingly, the eliminator can sufficiently eliminate static electricity from the fluids passing through the hollow even when the fluids have a low conductivity. In particular, the electric resistance of the rod is controlled by the surface area of the inner wall of the hollow, and the pressure loss of the fluids is controlled by the cross-sectional area of the hollow. When the rod includes the fins, the surface area of the inner wall of the hollow can be easily designed by the surface areas of the fins, and the cross-sectional area of the hollow can be easily designed by the intervals between the fins. Hence, optimization of the inner wall's surface area and cross-sectional area of the hollow enables static electricity to be eliminated from the entirety of the fluids while keeping a low-pressure loss thereof.

When having the above-mentioned fixing portion, the static electricity eliminator can use the structure of any existing manifold without any modification to fix the static electricity eliminating rod and form a seal. This can simplify both attachment and detachment of the eliminator and can ensure both high stability of the rod and high reliability of the seal. In addition, the above-mentioned hollow piecing the rod may extend to the inside of a branch pipe of the manifold to increase its inner wall's surface area and cross-sectional area, or alternatively, one or more additional hollows piecing the rod may be formed inside the branch pipe to increase the total inner wall's surface area and total cross-sectional area of the hollows. The larger (total) inner wall's surface area can further reduce the electric resistance of the rod, and the larger (total) cross-sectional area can further reduce the pressure loss of fluids.

### BRIEF DESCRIPTION OF DRAWINGS

FIG. 1 is a perspective view of a static electricity eliminator according to Embodiment 1 of the invention;

FIG. 2 is a longitudinal cross-section view of the eliminator cut by a plane including the line II-II shown in FIG. 1;

FIG. 3 is a transverse cross-section view of the eliminator cut by a plane including the line III-III shown in FIG. 1;

FIG. 4 is a longitudinal cross-section view of a static electricity eliminator according to Embodiment 2 of the invention;

FIG. 5 is a transverse cross-section view of the eliminator shown in FIG. 4;

FIG. 6 is a longitudinal cross-section view of a modified example of the eliminator according to Embodiment 2; and

FIG. 7 is a transverse cross-section view of the eliminator shown in FIG. 6.

### DESCRIPTION OF EMBODIMENTS

The following will describe embodiments of the invention with reference to the figures.

### Embodiment 1

### Structure of Static Electricity Eliminator

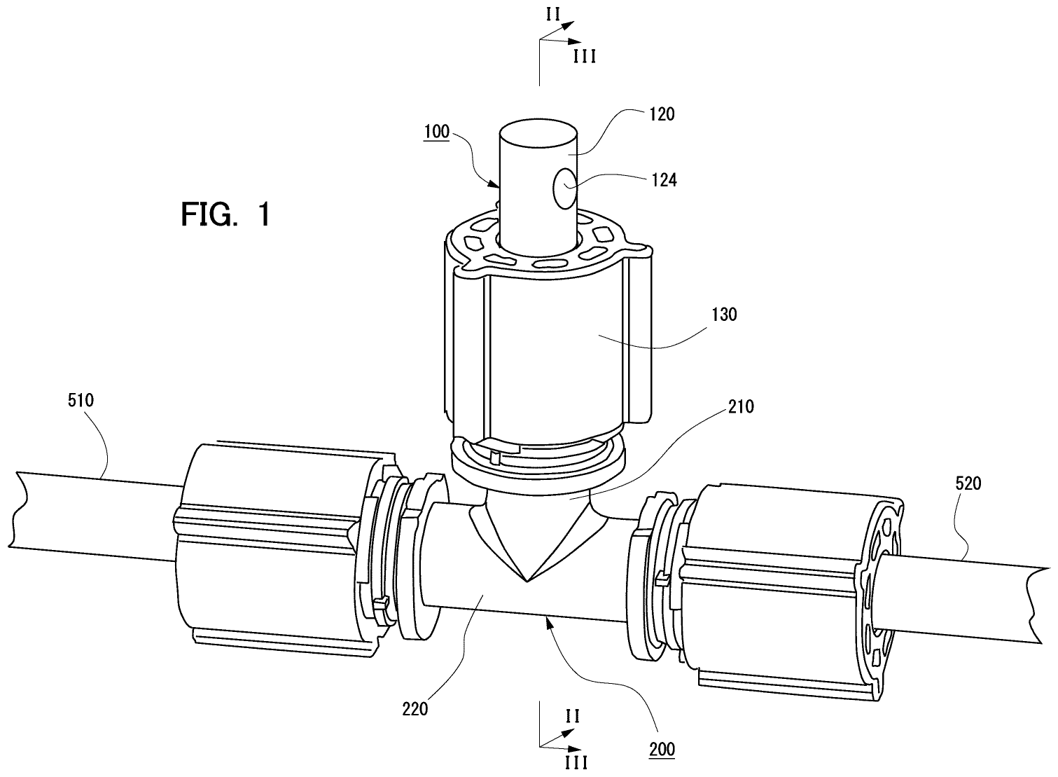

FIG. 1 is a perspective view of a static electricity eliminator 100 according to Embodiment 1 of the invention. The eliminator 100 closes a branch pipe 210 of a tee 200, for example. The tee 200, which is also called as a T-tube, is a pipe fitting in a trifurcated form; The branch pipe 210 extends perpendicularly, i.e., upwards in FIG. 1, from a straight main pipe 220 of the tee 200. The main pipe 220 connects a tube 510 with another tube 520. The tee 200 is preferably made of fluororesin such as polyvinylidene fluoride (PVDF), polytetrafluoroethylene (PTFE), or perfluoroalkoxy alkane (PFA). The tubes 510 and 520 are preferably made of fluororesin such as PTFE or PFA.

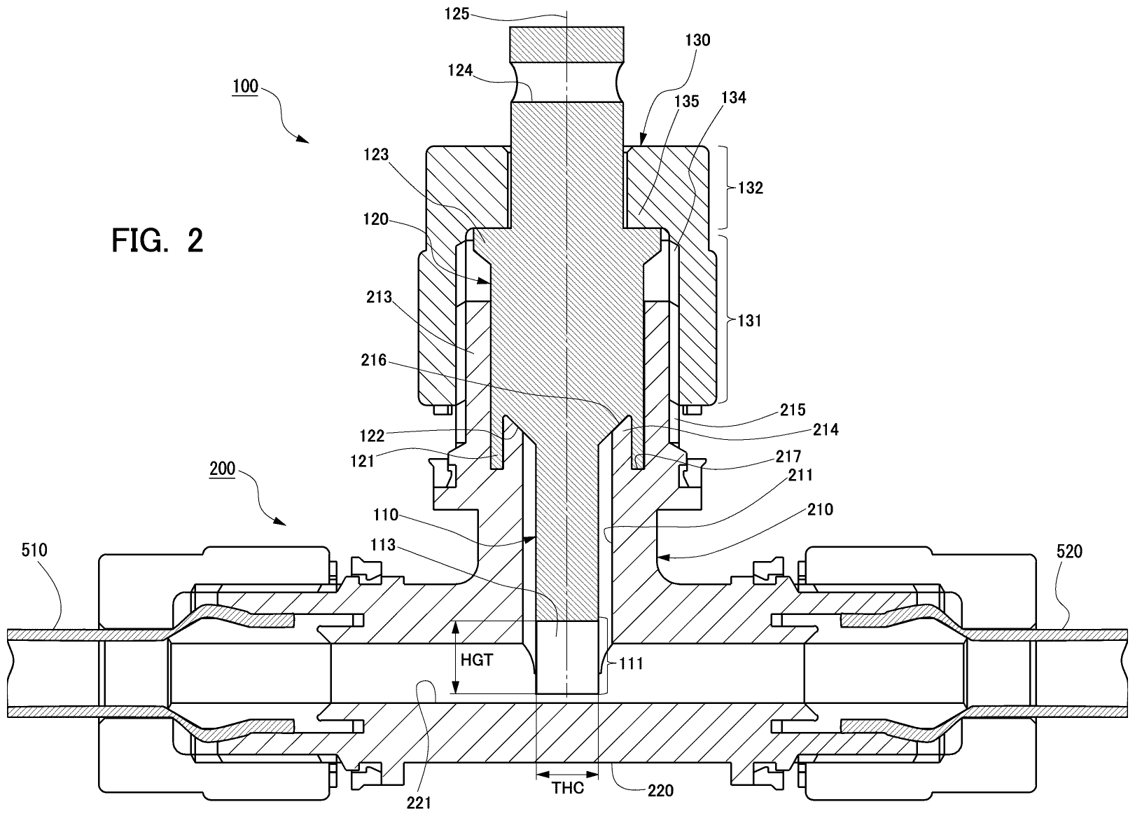

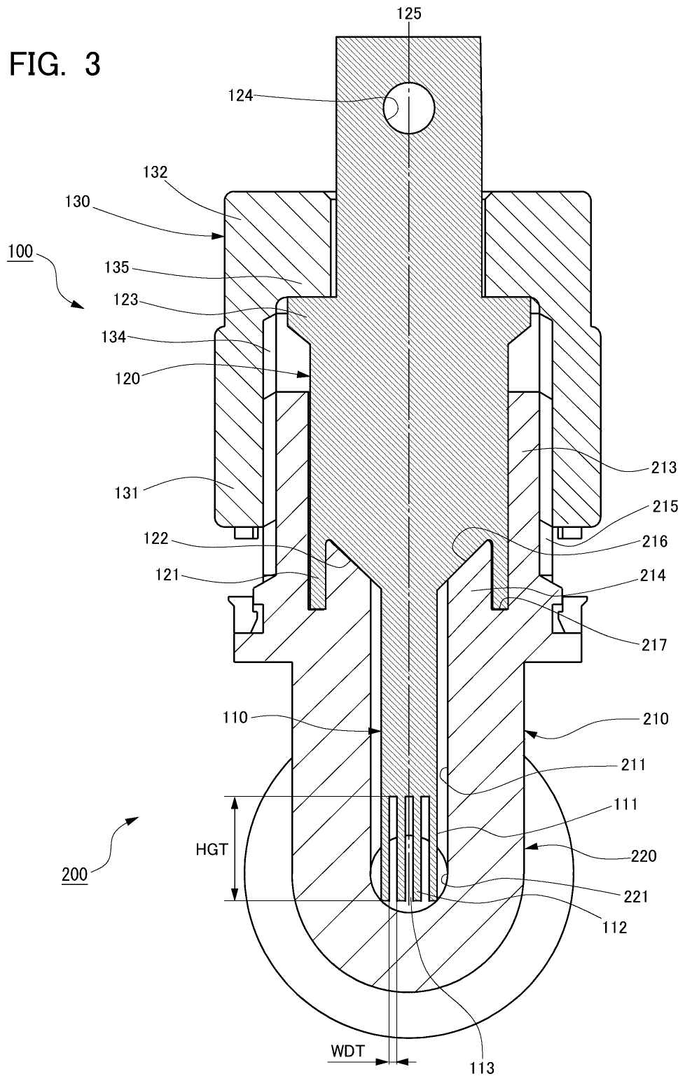

FIG. 2 is a longitudinal cross-section view of the static electricity eliminator 100 cut by a plane including a line II-II shown in FIG. 1, i.e., a view of a cross-section parallel to the longitudinal direction of the main pipe 220 of the tee 200. FIG. 3 is a transverse cross-section view of the eliminator 100 cut by another plane including a line III-III shown in FIG. 1, i.e., a view of a cross-section perpendicular to the longitudinal direction of the main pipe 220. As shown in FIG. 2, the main pipe 220 includes a flow path 221 connecting the two tubes 510 and 520. The branch pipe 210 of the tee 200 includes a branch path 211, which extends from an intermediate section of the flow path 221 in a direction perpendicular to the direction of the flow path 221, i.e., the left-right direction in FIG. 2. In FIG. 2, the branch pipe 210 extends upwards. A leading end portion of the branch pipe 210, i.e., its top end portion in FIGS. 2 and 3, includes a double-layered structure of an outer sleeve 213 and an inner sleeve 214. The external surface of the outer sleeve 213 includes an external thread 215. The leading end of the inner sleeve 214, i.e., its top end in FIGS. 2 and 3, includes an inverse tapered, truncated cone surface 216. Portions of the inner surface of the outer sleeve 213 and the outer surface of the inner sleeve 214 facing each other define an annular groove 217.

Inside the outer sleeve 213 of the branch pipe 210, the static electricity eliminator 100 is removably placed to close the branch path 211. As shown in FIGS. 2 and 3, the eliminator 100 includes a static electricity eliminating rod 110, a fixing portion 120, and a union nut 130.

The static electricity eliminating rod 110 is a square-rod-shaped member, whose cross-section perpendicular to its longitudinal direction, i.e., transverse cross-section is smaller than the transverse cross-section of the branch path 211 of the tee 200. The rod 110 is placed coaxially inside the branch path 211 and extends from the inside of the branch path 211 to the center portion of the flow path 221 or farther. The rod 110 is made of resin more conductive than fluororesin, preferably fluororesin, such as PFA, with conductive material, such as carbon fibers, dispersed therein, and thus the rod 110 is more conductive than the tee 200.

The leading end portion 111 of the static electricity eliminating rod 110, i.e., its lower end portion in FIGS. 2 and 3, is placed inside the flow path 221 of the tee 200 to intersect with the center portion of the flow path 221. The leading end portion 111 includes four fins 112, as shown in FIG. 3. Each fin 112 is parallel to the direction of the flow path 221, i.e., in the left-right direction in FIG. 2, and the fins 112 are equally spaced in the direction perpendicular to the direction of the flow path 221, i.e., in the left-right direction in FIG. 3, to define three slits 113. Each slit 113 is a hollow piecing the rod 110 in the direction parallel to the direction of the flow path 221 and extends from the leading end of the rod 110, i.e., its lower end in FIGS. 2 and 3, to the inside of the branch path 211. The depth THC of each slit 113, i.e., the width of each fin 112 (or its size in the direction of the flow path 221), is narrower than the inner diameter of the branch path 211. The width WDT of each slit 113, i.e., each interval between the fins 112 is about 10% of the inner diameter of the flow path 221. The height HGT of each slit 113, i.e., the length of each fin 112 (its size in the direction perpendicular to the direction of the flow path 221, i.e., in the vertical direction in FIGS. 2 and 3), is about one-and-a-half times as long as the inner diameter of the flow path 221. Since the rod 110 prevents penetration of fluids flowing from the tube 510 or 520 into the flow path 221, the fluids not only flow around the rod 110 but also pass through each slit 113. In particular, the fluids that have passed through the center portion of the flow path 221 flow into the center slit 113.

The fixing portion 120 is a cylindrical member whose leading end, i.e., its lower end in FIGS. 2 and 3, is coaxially connected to the base end of the static electricity rod 110, i.e., its upper end in FIGS. 2 and 3. The fixing portion 120 has an outer diameter substantially equal to the inner diameter of the outer sleeve 213 of the tee 200, i.e., the difference between the outer diameter of the fixing portion and the inner diameter of the outer sleeve 213 is equal to an acceptable dimensional error or less, and the fixing portion 120 removably closes the outer sleeve 213. In other words, the fixing portion 120 is formed as a closure. Like the rod 110, the fixing portion 120 is made of high-conductivity resin and more conductive than the tee 200. The base end of the fixing portion 120, i.e., its upper end in FIGS. 2 and 3, is connected to a ground electrode (not shown) via conductive wires or the likes (not shown). Preferably, the fixing portion 120 is integrally formed with the rod 110, and thus, the potential of the entirety of the rod 110 and the fixing portion 120 is kept at the ground potential.

The leading end portion of the fixing portion 120, i.e., its lower end portion in FIGS. 2 and 3, includes an annular protrusion 121 and a tapered, truncated cone surface 122. The annular protrusion 121 extends from the whole circumference of the fixing portion 120 in an axial direction, i.e., downwards in FIGS. 2 and 3, and is pressed into the annular groove 217 of the tee 200. In particular, the inner diameter of the annular protrusion 121 is slightly narrower than the outer diameter of the inner sleeve 214 of the tee 200. Accordingly, the inner periphery of the annular protrusion 121 and the outer periphery of the inner sleeve 214 tightly contact each other to form a seal. The truncated cone surface 122 of the fixing portion 120 is placed coaxially inside the base end of the annular protrusion 121, i.e., its upper end in FIGS. 2 and 3, to tightly contact the truncated cone surface 216 of the inner sleeve 214.

The base end portion of the fixing portion 120, i.e., its upper end portion in FIGS. 2 and 3, includes a flange 123 and a grip hole 124. The flange 123 radially extends from the outer periphery of the fixing portion 120 to close to the outer periphery of the outer sleeve 213 of the tee 200. The grip hole 124 is a through hole extending straight in the direction perpendicular to the center axis 125 of the fixing portion 120. When the fixing portion 120 is removed from the branch pipe 210 of the tee 200, a bar-shaped grip (not shown) is inserted into the grip hole 124 to be used for pulling the fixing portion 120 out of the branch pipe 210. Preferably, the longitudinal direction of the grip hole 124 is parallel to the direction of each fin 112 of the static electricity eliminating rod 110, i.e., the direction of the flow path 221 of the tee 200. When the fixing portion 120 is attached to the branch pipe 210, aligning the direction of the grip hole 124 with the direction of the flow path 221 can position the fins 112 to be parallel to the direction of the flow path 221.

The union nut 130 is a cylindrical member made of, preferably, fluororesin such as PVDF, PTFE, or PFA, and it coaxially surrounds the fixing portion 120 and the outer sleeve 213 of the tee 200. The leading end portion 131 of the union nut 130, i.e., its lower end portion in FIGS. 2 and 3, has an inner periphery with an inner thread 134, and its base end portion 132, i.e., its upper end portion in FIGS. 2 and 3, has an inner periphery with a ledge 135. The inner thread 134 is engaged with the external thread 215 of the outer sleeve 213. The ledge 135 is a portion of the inner periphery of the union nut 130 whose inner diameter is narrower than that of the inner thread 134, and it contacts the opposite side of the flange 123 of the fixing portion 120 from the static electricity eliminating rod 110, i.e., the upper side of the flange 123 in FIGS. 2 and 3. Thus, when the inner thread 134 of the union nut 130 is screwed onto the external thread 215 of the outer sleeve 213, the axial force from the union nut 130 is applied by the ledge 135 to the flange 123 and then transmitted to the annular protrusion 121 and truncated cone surface 122 of the fixing portion 120. As a result, the inner periphery of the annular protrusion 121 increases seal pressure against the outer periphery of the inner sleeve 214 of the tee 200, and the truncated cone surface 122 forms a seal in conjunction with the truncated cone surface 216 of the inner sleeve 214. Thus, the branch path 211 of the tee 200 is doubly sealed.

### Effect of Static Electricity Eliminator

The static electricity eliminator 100 uses the static electricity eliminating rod 110 to guide, into the slits 113 of the rod 110, fluids passing through the center portion of the flow path 221 in the tee 200. Since all of the slits 113 and the gap between the rod 110 and the inner wall of the flow path 221 are narrower than the flow path 221, charges accumulated by the fluids can escape to the rod 110 during passage of the fluids through the rod 110 even when the fluids have a low conductivity like ultrapure water or the like. Accordingly, static electricity can be sufficiently eliminated from both the fluids passing through the slits 113 and those flowing around the rod 110. In particular, the electric resistance of the rod 110 is controlled by the surface area, THC by HGT, of each inner wall of the slits 113 (cf. FIG. 2), and the pressure loss of the fluids caused by the rod 110 is controlled by the cross-sectional area, WDT by HGT, of each slit 113 (cf. FIG. 3). The surface area of each inner wall of the slits 113 can be easily designed by the width THC and height HGT of each fin 112, and the cross-sectional area of each slit 113 can be easily designed by the interval WDT between the fins 112 and the height HGT of each fin 112. Thus, optimization of the inner wall's surface area and cross-sectional area of each slit 113 enables elimination of static electricity from the entirety of the fluids while keeping a low-pressure loss of the fluids.

Since the fixing portion 120 is formed as a closure, the structure of any existing tee 200, especially the double seal structure formed by the outer sleeve 213 and the inner sleeve 214, is usable, without any modification, for fixing the static electricity eliminating rod 110 and for sealing the branch path 211. This enables easy attachment and detachment of the static electricity eliminator 100 and ensures both high stability of the rod 110 and high reliability of the seal. In addition, each slit 113 reaching the inside of the branch path 211 of the tee 200 can have not only an inner wall's surface area large enough to easily lower the electric resistance of the rod 110 but also a cross-sectional area large enough to easily reduce the pressure loss of the fluids.

### Modifications

(1) Although the static electricity eliminator 100 closes the branch pipe 210 of the tee 200, the invention is not limited to that. For example, the eliminator 100 may close one open end of the main pipe 220. In that case, a space extending from another open end of the main pipe 220 to the branch path 211 only has to be used as a flow path. Instead of the tee 200, a Y-tube, cross, or manifold with four open ends or more may be used as the fitting.
(2) The shapes and sizes of parts of the static electricity eliminator 100 are illustrative only. For example, the static electricity eliminating rod 110 may be shaped as a round rod or flat plate, instead of the square rod. The number of the fins 113 is not limited to four, but it may be three or less, or five or more. The surface of each fin 113 may be not flat but curved. Instead of the fins 113, an array of rod-shaped members may be provided at the leading end portion 111 of the rod 110.
(3) In the static electricity eliminator 100, the static electricity eliminating rod 110 and the fixing portion 120 are integrally formed from the same conductive resin, and thus, the entirety of the eliminator 100 is conductive. Alternatively, only the rod 110 may be formed from conductive resin. This only requires conductive elements such as conductive wires embedded in the fixing portion 120 and electrically connecting the rod 110 to an external ground electrode.

### Embodiment 2

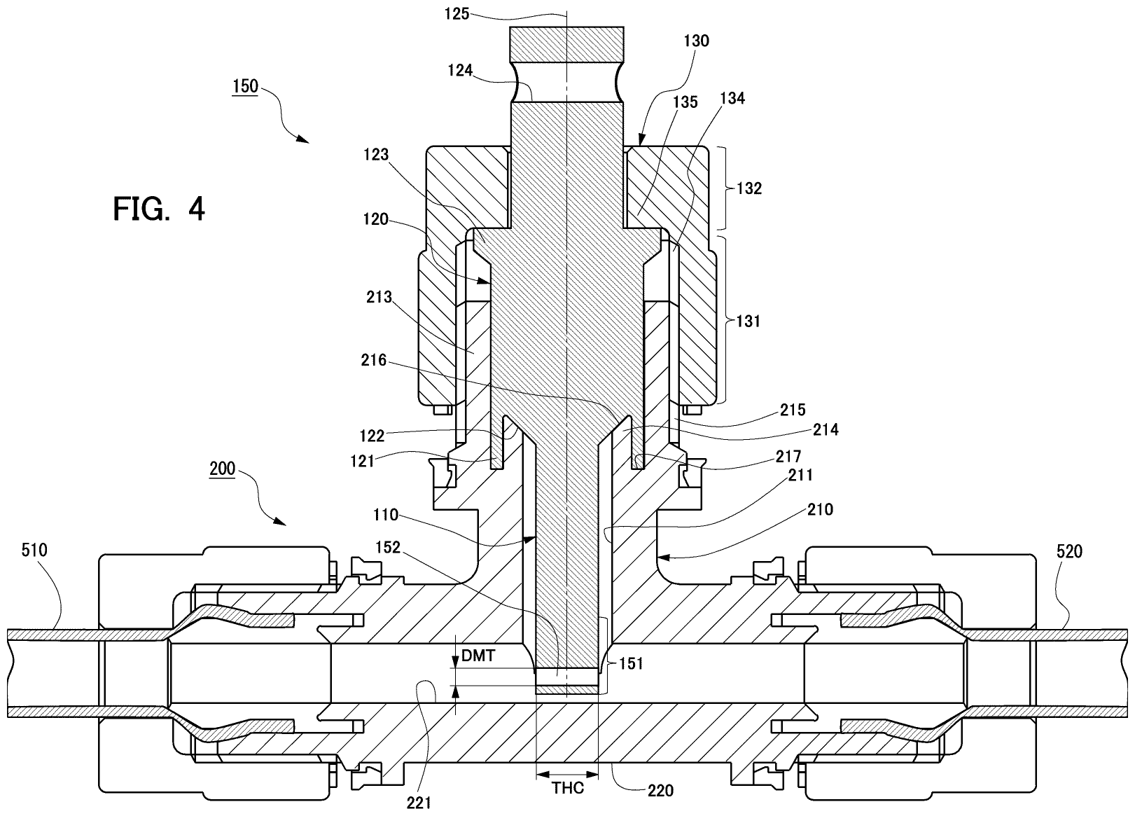

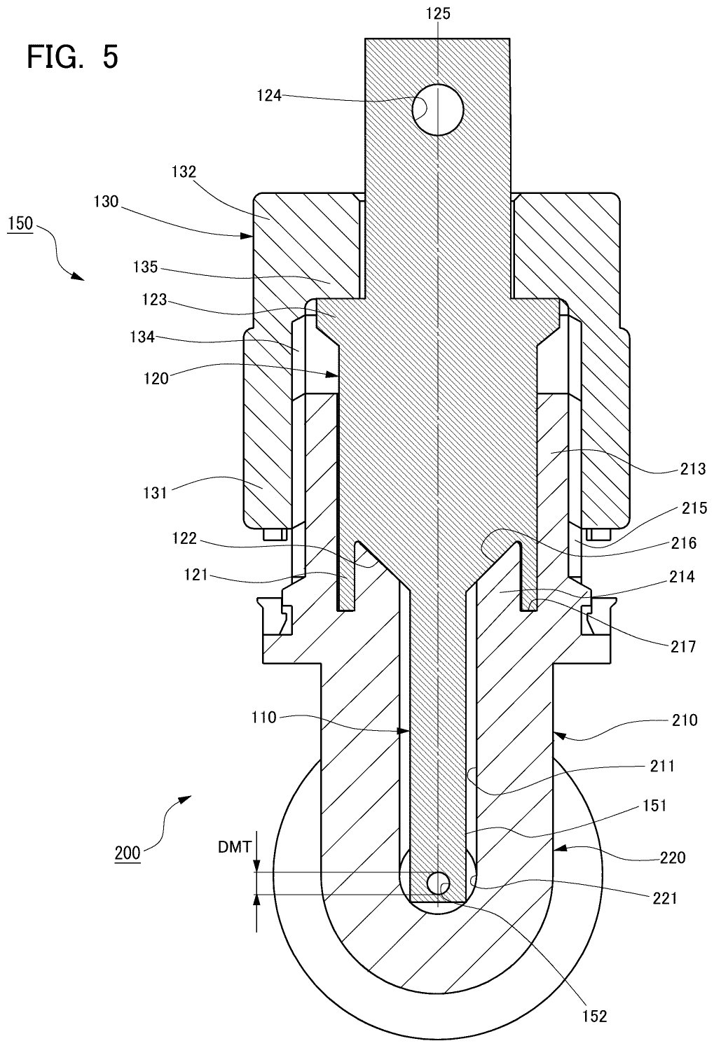

FIG. 4 is a longitudinal cross-sectional view of a static electricity eliminator 150 according to Embodiment 2 of the invention. FIG. 5 is a transverse cross-sectional view of the eliminator 150 shown in FIG. 4. Compared to the eliminator 100 according to Embodiment 1, the eliminator 150 according to Embodiment 2 has the same structures except for the structure of the leading end portion 151 of the static electricity eliminating rod 110. Accordingly, the following will describe only the different structures, and explanation on the same structures can be found in the previous description on Embodiment 1.

The static electricity eliminating rod 110 has a round-rod-like shape, and its leading end portion 151, i.e., its lower end portion in FIGS. 4 and 5, is placed inside the flow path 221 of the tee 200 to intersect with the center portion of the flow path 221. As shown in FIG. 5, the leading end portion 151 includes a circular cylindrical hollow 152, which pierces the rod 110 in the direction of the flow path 221, i.e., the left-right direction in FIG. 4. The depth THC of the hollow 152 is narrower than the inner diameter of the branch path 211. The inner diameter DMT of the hollow 152 is, for example, about 25% of the inner diameter of the flow path 221. In the radial direction of the flow path 221, the hollow 152 is placed at the center portion of the flow path 221. Since the rod 110 prevents penetration of fluids that flow from the tube 510 or 520 into the flow path 221, the fluids not only flow around the rod 110 but also pass through the hollow 152. In particular, the fluids that have passed through the center portion of the flow path 221 flow into the hollow 152.

The static electricity eliminator 100 uses the static electricity eliminating rod 110 to guide, into the hollow 152 of the rod 110, the fluids passing through the center portion of the flow path 221 in the tee 200. Since both the hollow 152 and the gap between the rod 110 and the inner wall of the flow path 221 are narrower than the flow path 221, charges accumulated in the fluids can escape to the rod 110 during passage of the fluids through the rod 110 even when the fluids have a low conductivity like ultrapure water or the like. Accordingly, static electricity can be sufficiently eliminated from both the fluids passing through the hollow 152 and those flowing around the rod 110. In particular, the electric resistance of the rod 110 is controlled by the surface area of the leading end portion 151 of the rod 110 and the surface area, 2π by DMT by THC, of the inner wall of the hollow 152 (cf. FIG. 4), and the pressure loss of the fluids caused by the rod 110 is controlled by the cross-sectional area, π by DMT², of the hollow 152 (cf. FIG. 5). Thus, optimization of the inner wall's surface area and cross-sectional area of the hollow 152 enables elimination of static electricity from the entirety of the fluids while keeping a low-pressure loss of the fluids.

### Modifications

The shape and size of the hollow 152 are illustrative only. For example, the transverse cross-section of the hollow 152 may be formed as an ellipse or a polygon, instead of a circle. The number of the hollow 152 is not limited to one, but it may be two or more.

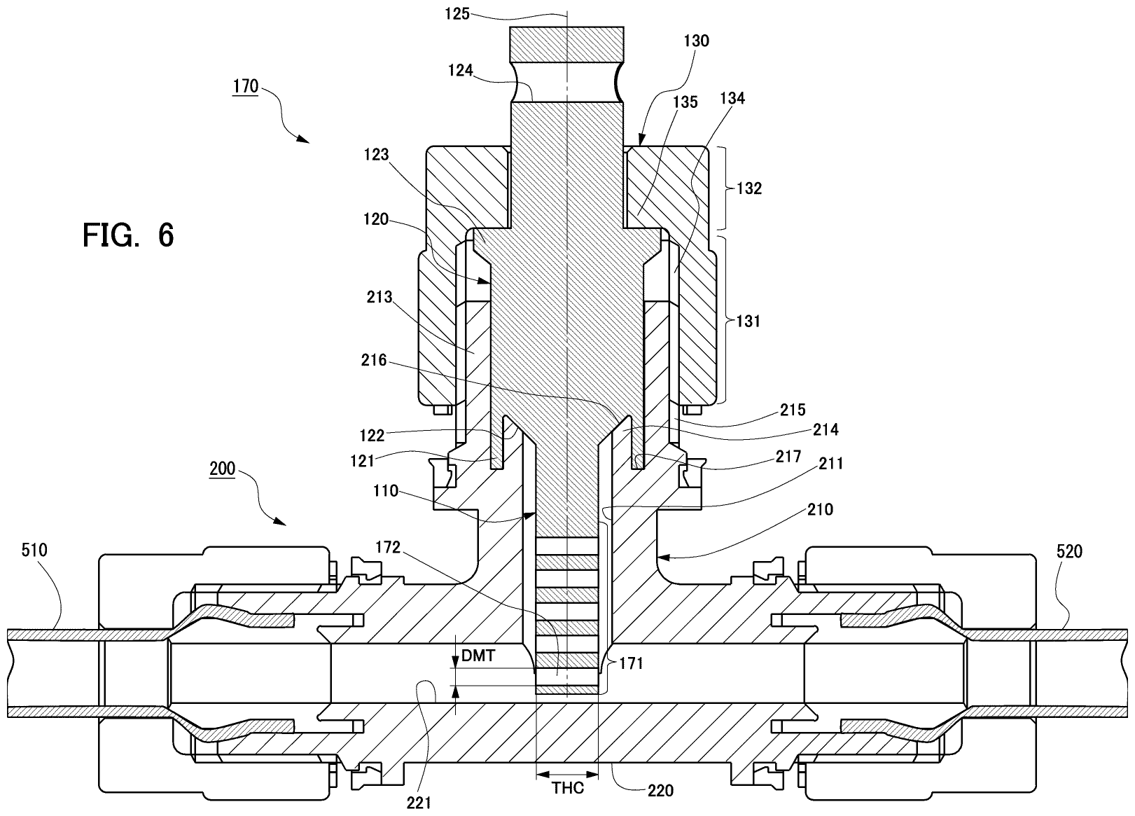

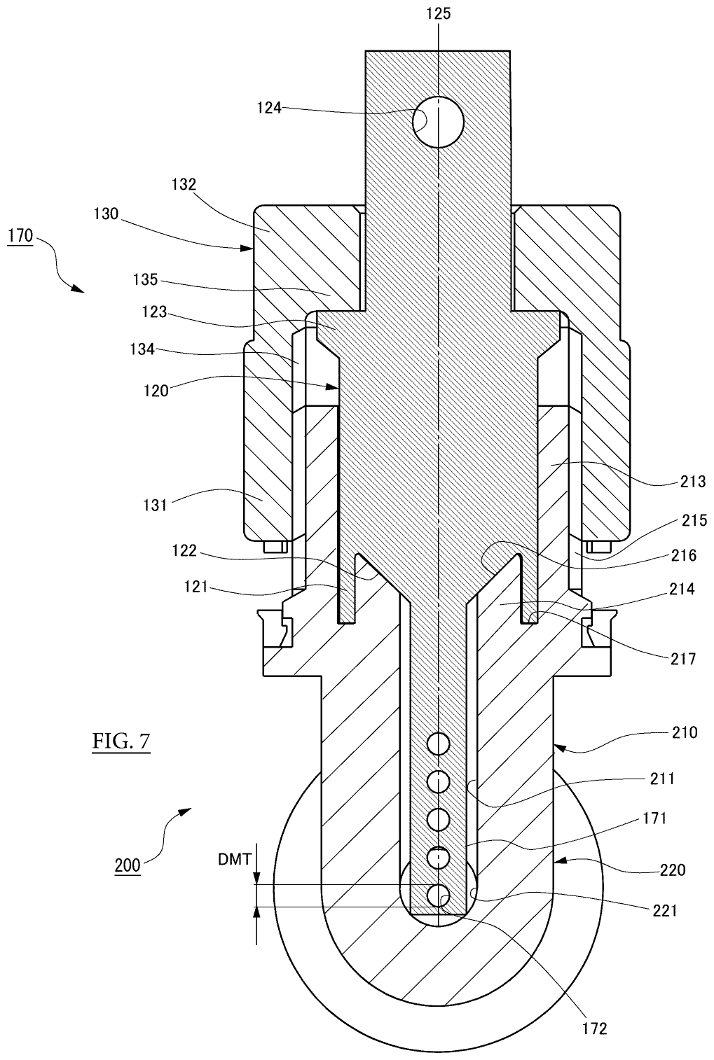

FIG. 6 is a longitudinal cross-sectional view of a modification 170 of the static electricity eliminator according to Embodiment 2 of the invention. FIG. 7 is a transverse cross-sectional view of the eliminator 170 shown in FIG. 6. Compared to the eliminator 110 according to Embodiment 1, the eliminator 170 according to the modification of Embodiment 2 has the same structures except for the structure of the leading end portion 171 of the static electricity eliminating rod 110. Accordingly, the following will describe the different structures, and an explanation on the same structures can be found in the previous description on Embodiment 1.

The static electricity eliminating rod 110 has a round-rod-like shape, and its leading end portion 171, i.e., its lower end portion in FIGS. 6 and 7, is placed inside the flow path 221 of the tee 200 to intersect with the center portion of the flow path 221. As shown in FIG. 6, the leading end portion 171 includes two or more hollows 172, e.g., five hollows in FIGS. 6 and 7. Each hollow 172 pierces the rod 110 in the direction of the flow path 221, i.e., the left-right direction in FIG. 6. The depth THC of each hollow 172 is narrower than the inner diameter of the branch path 211. The hollows 172 have the same inner diameter DMT that is, for example, about 25% of the inner diameter of the flow path 221. In the direction perpendicular to the direction of the flow path 221, i.e., the vertical direction in FIGS. 6 and 7, the hollows 172 are arranged in a row and equally spaced within a range along the center axis 125 of the rod 110 from the inside of the branch path 211 to the center portion of the flow path 221 or farther. Alternatively, the hollows 172 may be arranged in two or more rows, or different hollows 172 may have different inner diameters or shapes, or the hollows 172 may be not equally spaced. Since the rod 110 prevents penetration of fluids that flow from the tube 510 or 520 into the flow path 221, the fluids not only flow around the rod 110 but also pass through all the hollows 172. In particular, the fluids that have passed through the center portion of the flow path 221 flow into one of the hollows 172 closest to the leading end of the rod 110.

The static electricity eliminator 100 uses the static electricity eliminating rod 110 to guide, into the hollows 172 of the rod 110, the fluids passing through the center portion of the flow path 221 in the tee 200. Since all of the hollows 172 and the gap between the rod 110 and the inner wall of the flow path 221 are narrower than the flow path 221, charges accumulated in the fluids can escape to the rod 110 during passage of the fluids through the rod 110 even when the fluids have a low conductivity like ultrapure water or the like. Accordingly, static electricity can be sufficiently eliminated from both the fluids passing through the hollows 172 and those flowing around the rod 110. In particular, the electric resistance of the rod 110 is controlled by the surface area of the rod 110 and the total surface area of the inner walls of the hollows 172, 2π by DMT by THC by the number of the hollows 172 (cf. FIG. 6), and the pressure loss of the fluids caused by the rod 110 is controlled by the total cross-sectional area of the hollows 172, π by DMT² by the number of the hollows 172 (cf. FIG. 7). Thus, optimization of the total inner walls' surface area and total cross-sectional area of the hollows 172 enables elimination of static electricity from the entirety of the fluids while keeping a low-pressure loss of the fluids.

What is claimed is:

1. A static electricity eliminator for eliminating static electricity from a fluid inside a pipe, comprising:
a static electricity eliminating rod made of conductive resin, configured to prevent penetration of the fluid, grounded electrically, placed inside a flow path in the pipe to intersect with a center portion of the flow path, and including
a hollow positioned to intersect with the center portion of the flow path and piercing the static electricity eliminating rod in a direction parallel to the flow path.

2. The static electricity eliminator according to claim 1, wherein:
the static electricity eliminating rod includes a plurality of fins, each of which is parallel to the flow path; and
the hollow is a slit defined by the plurality of fins.

3. The static electricity eliminator according to claim 1, further comprising
a fixing portion formed as a closure that removably closes, when the pipe is a manifold, a branch pipe of the manifold, wherein
the static electricity eliminating rod extends from the fixing portion through the branch pipe to the center portion of the flow path or farther.

4. The static electricity eliminator according to claim 3, wherein:
the static electricity eliminating rod includes a plurality of fins, each of which extends from the inside of the branch pipe to the center portion of the flow path or farther in a direction parallel to the flow path; and
the hollow is a slit defined by the plurality of fins.
